(19) United States
(12) Patent Application Publication
(10) Pub. No.: US 2008/0294447 A1
(43) Pub. Date: Nov. 27, 2008

(54) Issue or transaction tracking by using presence information and instant messaging

(75) Inventor: Robert C. Steiner, Broomfield, CO (US)

Correspondence Address: AVAYA INC., 307 MIDDLETOWN-LINCROFT ROAD, ROOM 1N-391, LINCROFT, NJ, 07738, US

(73) Assignee: Avaya Technology LLC

(21) Appl. No.: 11/805,019

(22) Filed: May 22, 2007

(51) Int. Cl. G06Q 10/00; G06F 17/30

(52) U.S. Cl. 705/1

(57) ABSTRACT

A presentity is used to represent and report states of an issue or a transaction. The issue or the transaction is an intangible (an incorporeal, non-physical) entity. The presentity for the issue or the transaction is created, a state of the issue or the transaction received from a handler of the issue or the transaction is registered in the presentity, and the registered state is reported to watchers of the presentity. Preferably, a handler registers with the presentity as a proxy for the issue or the transaction, and messages sent to the presentity are forwarded to the handler who is the registered proxy. If the issue or the transaction comprises a plurality of entities, preferably a separate presentity for each one of the entities, as well as for the issue or the transaction as a whole, is created and used.

### TECHNICAL FIELD

This invention relates to the use of presence information.

### BACKGROUND OF THE INVENTION

Presence information is a status indicator that is normally used to convey ability and willingness of a communication partner to communicate. A client provides presence information, called “presence state”, to a presence service, where the presence state is stored in a record of the client's availability, called a “presentity”. From there, the presence state is made available to users, called “watchers”, who have subscribed with the presence service to receive the client's presence state.

Presence information is one of the drivers of instant messaging (IM), which is a form of real-time text communication between parties over a network. A client publishes its presence state to indicate its communication status, such as “free,” “busy,” “away,” “do not disturb,” etc. This published state informs watchers who wish to contact the client of his or her availability and willingness to communicate. The status is used to display an indicator icon on a watcher's instant messaging interface that indicates to the watcher the present availability of the client to engage in an IM session.

Presence information is currently used to track communications status of tangible, physical entities, namely persons. To the inventor's knowledge, presence information has not been used to track status—communications or otherwise—of intangible entities, such as progress of issues to resolution or the progress of transactions to completion.

An illustrative example of a transaction is fulfillment of an order for goods or a service. To find the status of an order, conventionally a customer would either go to a website or call a call center, enter the order number, and in response get the order status. In tracking delivery of the order, the customer would visit the website of the delivery service and use a tracking number to get the current delivery status. The customer has to initiate the contact for each inquiry.

An alternative methodology for tracking fulfillment of an order enables the customer to register with the supplier and the shipper to receive order and shipping status by email. One registration is required to track the order status, and a separate registration is required to track the shipping status. Tracking status by email requires the customer to have an email application running, and to periodically check the email and filter out order and status-tracking messages from the other email messages in the customer's mailbox. This again requires the customer's active manual involvement in obtaining order and shipping status. It also makes email notification less desirable for customers who use small hand-held devices, like cell phones, to receive their email.

### SUMMARY OF THE INVENTION

This invention is directed to solving these and other problems and disadvantages of the prior art. Generally, according to the invention, a presentity is used to represent and report states of an issue or a transaction. The issue or the transaction is an intangible (an incorporeal, non-physical) entity. The presentity for the issue or the transaction is created, a state of the issue or the transaction received from a handler of the issue or the transactions is registered in the presentity, and the registered state is reported to watchers of the presentity. The presence state is thus pushed to the customer, instead of having to be pulled by the customer. A presence service reports presence state to watchers via instant messages, so the customer is informed of the changed state immediately and without having to take any action to obtain the changed state. Preferably, a handler registers with the presentity as a proxy for the issue or the transaction, and messages sent to the presentity are forwarded to the handler who is the registered proxy. If the issue or the transaction comprises a plurality of entities, preferably a separate presentity for each one of the entities, as well as for the issue or the transaction as a whole, is created and used.

The invention may be implemented as a method, an apparatus for performing the method, or a computer-readable medium containing instructions which, when executed by a computer, cause the computer to perform the method.

### BRIEF DESCRIPTION OF THE DRAWING

These and other features and advantages of the invention will become more apparent from considering the following description of an illustrative embodiment of the invention together with the drawing, in which:

FIG. 1 is a block diagram of a communications system that includes an illustrative embodiment of the invention;

FIGS. 2-4 are functional flow diagrams of a first illustrative embodiment of the invention in the system of FIG. 1; and

FIG. 5 is a functional flow diagram of a second illustrative embodiment of the invention in the system of FIG. 1

### DETAILED DESCRIPTION

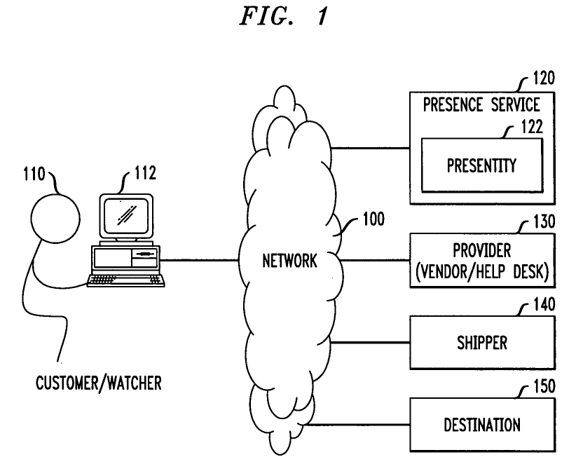

FIG. 1 shows a communications network that interconnects a communications device 112 of a customer 110 (hereinafter referred to jointly and severally as customer 110) with a provider of a presence service 120, a provider 130 of goods or services (such as a vendor of goods or a help desk, for example), a shipper 140 of the goods, and a delivery destination 150 of the goods.

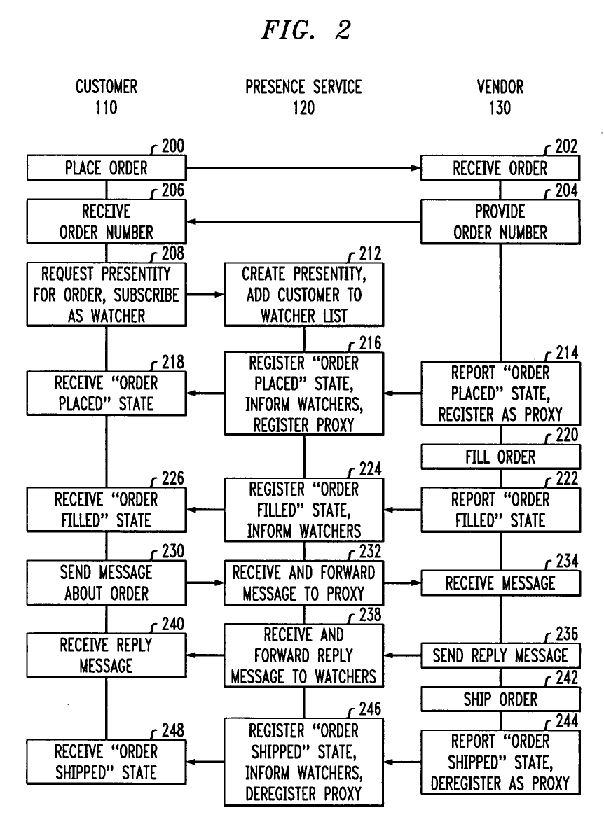

FIG. 1 serves as a context for one illustrative embodiment of the invention—order tracking. The order-tracking process is illustrated in FIGS. 2-4. For purposes of this embodiment, provider 130 is a vendor 130.

Customer 110 places an order for goods with vendor 130, at step 200 of FIG. 2, illustratively by calling a call center of vendor 130 or by filling out and submitting a web order page on the vendor's website. Vendor 130 receives the order, at step 202, and in response provides an order number to customer 110, at step 204. Assuming that customer 110 is a client of presence service 120, upon receiving the order number, at step 206, customer 120 registers the order with the presence service 120: customer 120 contacts presence service 120, gives it the order number, and requests it to create a presentity for the order, at step 208. Customer 110 also subscribes as a watcher to the presentity's presence, at step 208. Alternatively, if vendor 130 is a client of presence service 120, vendor 130 may perform step 208 on behalf of customer 110 based on an agreement with the customer 110. In response, presence service 120 creates a presentity 122 for the order in a conventional manner, and assigns the order number as an identifier to presentity 122, at step 212. To the vendor, the presentity represents the customer; to the customer, the presentity represents both the order and the vendor.

Having received the order at step 202, vendor 130 reports an “order placed” status for the order to presence service 120 in a conventional manner, and also requests presence service 120 to register vendor 130 as a proxy for the order, at step 214. Becoming registered as a proxy enables vendor 130 to receive messages about the order from customer 110 through presence service 120. Presence service 120 records the reported state in presentity 122 and also associates vendor 130 with presentity 122 as a proxy, at step 216. Recording of the state results in all recorded watchers of presentity 122, including customer 110, being sent an instant message notifying them of the state, in a conventional manner, at step 216. Customer 110 receives the instant message from presence service 120 at step 218.

The order may represent multiple items, and vendor 130 may or may not be able to fill the entire order all at once. If it cannot, a separate presentity 122 is created for each item of the original order. Thus, an order represents a group of entities that may have a plurality of states (multiple presences) simultaneously, one for each entity. There may be a higher-level presentity representing the order as a whole and subsuming the states of the presentities of the individual entities, whose state or “rich presence” indicates the overall state of the group, e.g., whether all items of the order have been shipped and whether all of the items have been delivered.

When vendor 130 has filled the order or a piece of it, at step 220, vendor 130 notifies presence service 120 of this change of state, at step 222. This may be done automatically: for example, the box in which the ordered goods have been packed may have an embedded RFID, and that RFID is automatically read by an RFID reader as the box is conveyed from the warehouse to the shipping dock. Presence service 120 records the new state in presentity 122 and notifies watchers including customer 110 of the new state via instant messages, at step 224. Customer 110 receives the instant message notifying it of the new state, at step 226.

If, at any time while vendor 130 is registered with presence service 120 as a proxy for the order, customer 110 sends an instant message to presence service 120 addressed to the order number, at step 230, presence service 120 receives the message, uses the order number to associate the message with presentity 122, determines from presentity 122 that vendor 130 is a proxy for the order, and forwards the message on to vendor 130, at step 232. Vendor 130 receives the message, at step 234, and sends an instant message reply to presence service 120, at step 236. Presence service 120 treats the reply essentially as a change of state and forwards it to all watchers of presentity 122, including customer 110, at step 238. Customer 110 receives the instant message reply, at step 240. Vendor 130 may likewise initiate communications to customer 110 and receive replies thereto via this mechanism.

When vendor 130 ships the order, at step 242, it notifies presence service 120 of this change of state and also requests presence service 120 to deregister vendor 130 as a proxy for the order, at step 244. Presence service 120 stores and reports the new state to watchers of presentity 122, including customer 110, via an instant message and deregisters vendor 130 as a proxy, at step 246. Customer 110 receives the instant message informing it of the new state, at step 248.

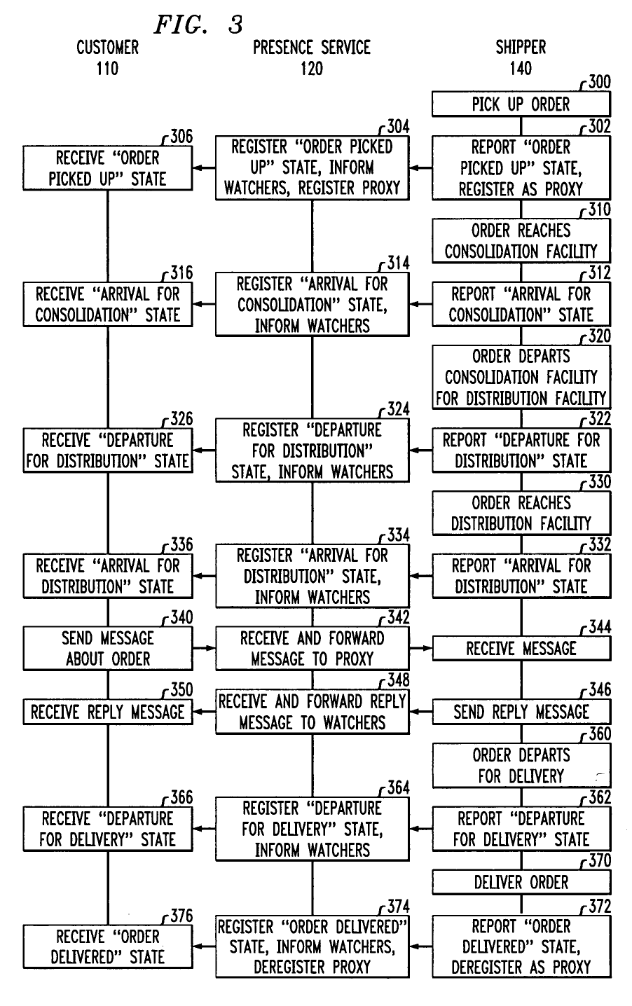

When shipper 140 picks up the order from vendor 130, at step 300 of FIG. 3, it reports this new state to presence service 120 and also requests presence service 120 to register shipper 140 as the new proxy for the order, at step 302. This may again be done automatically via the RFID and an RFID reader in the truck of shipper 140. Presence service 120 records the new state in presentity 122, records shipper 140 as the proxy with presentity 122 and notifies watchers of presentity 122 of the new state, at step 304. Customer 110 receives the instant message notification of the new state at step 306.

When the order arrives at a consolidation facility of shipper 140, at step 310, shipper 140 notifies presence service 120, at step 312. Presence service 120 records the new state in presentity 122 and notifies watchers of presentity 122, at step 314. Customer 110 receives an instant message notifying it of the new state, at step 316.

When the order leaves the consolidation facility of shipper 140 for a distribution facility of shipper 140, at step 320, shipper 140 notifies presence service 120, at step 322. Presence service 120 records the new state in presentity 122 and notifies watchers of presentity 122, at step 324. Customer 110 receives an instant message notifying it of the new state, at step 326.

When the order arrives at the distribution facility of shipper 140, at step 330, shipper 140 notifies presence service 120, at step 332. Presence service 120 records the new state in presentity 122 and notifies watchers of presentity 122, at step 334. Customer 110 receives an instant message notifying it of the new state, at step 336.

If, at any time while shipper 140 is registered with the presence service 120 as a proxy for the order, customer 110 sends an instant message to presence service 120 addressed to the order number, at step 340, presence service 120 forwards the message to shipper 140, at step 342. Shipper 140 receives the message, at step 344, and sends an instant message reply to presence service 120, at step 346. Presence service 120 relays the message to watchers of presentity 122, at step 348, and customer 110 receives the instant message, at step 350. Shipper 140 may likewise initiate communications to customer 110 and receive replies thereto via this mechanism.

When the order leaves distribution facility of shipper 140 for delivery to customer 110, at step 360, shipper 140 notifies presence service 120, at step 362. Presence service 120 records the new state in presentity 122 and notifies watchers of presentity 122, at step 364. Customer 110 receives an instant message notifying it of the new state, at step 366.

When shipper 140 delivers the order to its destination point 150, at step 370, shipper 140 notifies presence service 120 and also requests presence service 120 to deregister shipper 140 as a proxy for the order, at step 372. Presence service 120 records the new state in presentity 122 and notifies watchers of presentity 122 of the new state, at step 374. Presence service 120 also deregisters shipper 140 as a proxy, at step 374. Customer 110 receives an instant message notifying it of the new state, at step 376.

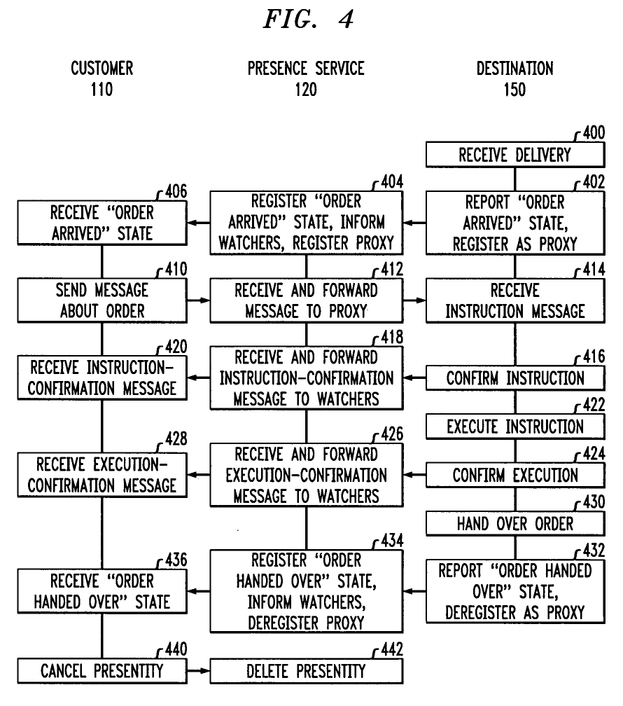

The delivery of the order to its destination point 150 may not have resulted in delivery of the order into the hands of customer 110. For example, the order may have been delivered to the shipping and receiving dock of the employer of customer 110. When such a delivery to a third party is effected and the third-party destination point 150 receives the order, at step 400 of FIG. 4, destination point 150 reports this new state to presence service 120 and also requests presence service 120 to register destination point 150 as the new proxy for the order, at step 402. Presence service 120 records the new state in presentity 122, records destination point 150 as the new proxy with presentity 122, and notifies watchers of presentity 122 of the new state, at step 404. Customer 110 receives the notification at step 406.

If, at any time while destination point 150 is registered with presence service 120 as a proxy for the order, customer 110 sends an instant message to presence service 120 addressed to the order number, at step 410, presence service 120 forwards the message to destination point 150, at step 412. For example, if destination point 150 is the customer's employer, customer 110 may request destination point 150 to forward the order to the customer's home. Destination point 150 receives the request, at step 414, and confirms the request, at step 416. Presence service 120 records and forwards the confirmation to customer 110, at step 418, and customer 110 receives it, at step 420.

When destination point 150 has executed the customer's request, at step 422, it confirms the execution, at step 424. Presence service 120 records and forwards the confirmation to customer 110, at step 426, and customer 110 receives, it at step 428. If the request was to forward the order to the customer's home, the process of FIG. 3 may be repeated with the shipper who ships the order from destination point 150 to the customer's home.

Eventually, the order finds its way into the customer's hands. Let us assume that customer 110 picked up the order at his or her employer's loading dock, or better yet, that the destination point 150 is the customer's home. When the order is handed over to customer 110, at step 430, and customer 110 receives it, at step 432, destination point 150 reports this new state to presence service 120 and also requests presence service 120 to deregister destination point 150 as a proxy for the order, at step 432. Presence service 120 records the new state in presentity 122 and notifies watchers of presentity 122 of the new state, at step 434. Presence service 120 also deregisters destination point 150 as a proxy, at step 434. Customer 110 receives an instant message notifying it of the new state, at step 436.

Delivery of the order having been completed, there is no more need for presentity 122. Customer 110 therefore requests presence service 120 to cancel presentity 122, at step 440, and presence service 120 deletes presentity 122, at step 442. Alternatively, if vendor 130 was also a watcher of presentity 122, when vendor 130 determines that delivery of the order has been completed, vendor 130 may perform step 440 on behalf of customer 110.

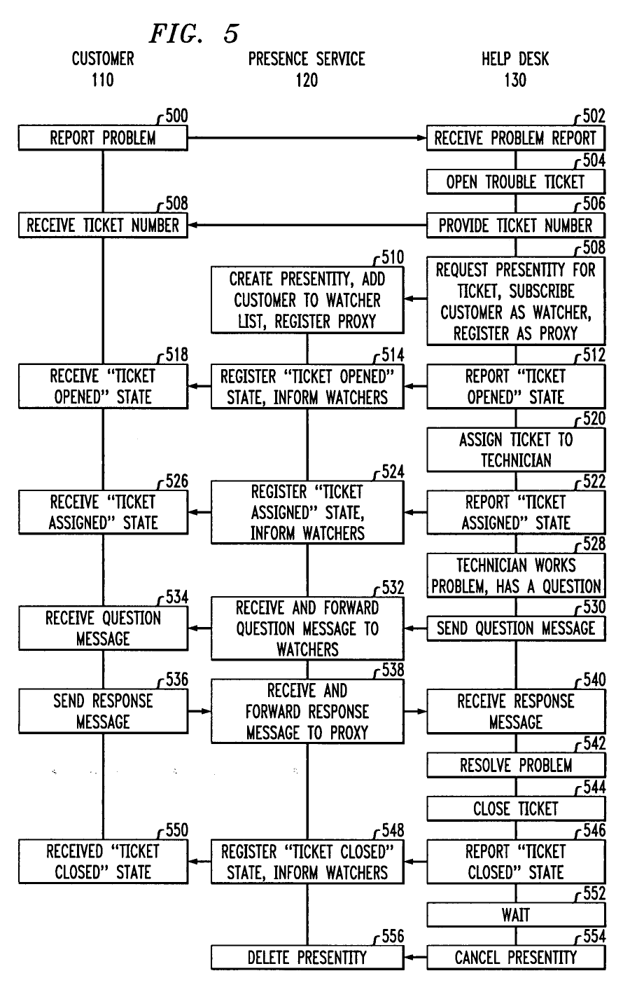

FIG. 5 shows a second embodiment of the invention where the invention is applied to an issue in a help desk setting. For purposes of this embodiment, provider 130 is a help desk 130 of FIG. 1.

When customer 110 encounters a problem with his or her computer 112, customer 110 reports the problem to help desk 130, at step 500, in a conventional manner, such as by calling help desk 130 or filling out a form on a website of help desk 130. Help desk 130 receives the problem report, at step 502, opens a trouble ticket for the problem, at step 504, and provides the ticket number to customer 110, at step 506, all in a conventional manner. Customer 110 receives the ticket number at step 508. Assuming that help desk 130 is a client of presence service 120, help desk 130 contacts presence service 120 and requests it to create a presentity 122 with customer 110 as a watcher, under the ticket number as its identifier, at step 508. Help desk 130 also requests presence service 120 to register help desk 130 as a proxy with presentity 122, at step 508. Presence service 120 creates presentity 122 and registers help desk 130 as a proxy, at step 510. Help desk 130 then reports the “ticket opened” state to presence service 120, at step 512. Presence service 120 registers the state in presentity 122 and notifies watchers thereof, at step 514. Customer 110 receives an IM message notifying it of the “ticket opened” state, at step 518.

When help desk 130 assigns the trouble ticket to a technician, at step 520, it reports this new state to presence service 120, at step 522. Presence service 120 registers the new state in presentity 122 and informs the watchers of presentity 122—customer 110, in this instance,—at step 524. Customer 110 receives the new state, at step 526.

As the technician works the problem, assume that he or he has a question, at step 528. The technician sends an instant message with the question addressed to the ticket number, to presence service 120, at step 530. Presence service 120 matches the ticket number to presentity 122 and forwards the message to watchers of presentity 122—customer 110, in this instance,—at step 532. Customer 110 receives the message, at step 534, and sends a reply thereto to presence service 120, at step 536. Presence service 120 forwards the reply to the proxy, which is help desk 130, at step 538. The technician receives the reply, at step 540, resolves the problem, at step 542, and closes the ticket, at step 534. Help desk 120 reports the “ticket closed” state to presence service 120, at step 546, and presence service 120 informs watchers of presentity 122—customer 110, in this instance,—of the new state, at step 548. Customer 110 receives the new state, at step 550.

Help desk 130 keeps presentity 122 in existence for some period of time, at step 552, to give customer 110 a chance to communicate to help desk 130 any other issues concerning the problem and its resolution. When that time expires, help desk 130 contacts presence service 120 and cancels presentity 122, at step 554. In response, presence service 120 deletes presentity 122, at step 556.

Of course, various changes and modifications to the illustrative embodiment described above will be apparent to those skilled in the art. For example, the invention may be used to automatically provide delivery performance and customer satisfaction information, services akin to registered mail, quality of service measurements and reporting, etc. The customer may be given more flexibility, such as to change their mind about an order during the delivery process, to switch their instant messaging between devices as their presence changes, etc. Or the invention, along with sensory such as RFIDs, may be used to track pets, children, documents, etc. These changes and modifications can be made without departing from the spirit and the scope of the invention and without diminishing its attendant advantages. It is therefore intended that such changes and modifications be covered by the following claims except insofar as limited by the prior art.

What is claimed is:

1. A method comprising:
creating a presentity for an issue or a transaction;
receiving a state of the issue or the transaction from a handler of the issue or the transaction;
registering the state in the presentity; and
reporting the registered state to watchers of the presentity.

2. The method of claim 1 wherein:
the issue or the transaction is an intangible entity.

3. The method of claim 1 wherein:
the issue or the transaction comprises a plurality of entities;
creating comprises
creating a separate presentity for each one of the entities, and
creating a separate presentity for the issue or the transaction as a whole;
receiving comprises
receiving a state of one of the entities;
registering comprises
registering the state of the one entity in the presentity of the one entity,
determining a state of the issue or the transaction as the whole, and
registering the state of the issue or the transaction as a whole in the presentity of the issue or the transaction as the whole;
reporting comprises
reporting the state of the entity to the watchers of the presentity of the entity, and
reporting the state of the issue or the transaction as the whole to the watchers of the presentity of the issue or the transaction as a whole.

4. The method of claim 1 further comprising:
registering the handler with the presentity as a proxy for the issue or the transaction;
sending a message to the presentity;
determining the registered proxy from the presentity; and
forwarding the message to the handler that is the registered proxy.

5. The method of claim 4 further comprising:
the handler handing off the issue or the transaction to a second handler;
deregistering initial said handler as the proxy from the presentity; and
registering the second handler as the proxy for the issue or the transaction with the presentity.

6. A computer-readable storage medium containing instructions which, when executed by a computer, cause the computer to perform the method of one of claims 1-5.

7. An apparatus comprising:
a presence service adapted to create a presentity for an issue or a transaction, receive a state of the issue or the transaction from a handler of the issue or the transaction, register the state in the presentity, and report the registered state to watchers of the presentity.

8. The apparatus of claim 7 wherein:
the issue or the transaction is an intangible entity.

9. The apparatus of claim 7 wherein:
the issue or the transaction comprises a plurality of entities; and
the presence service is adapted to create a separate presentity for each one of the entities, create a separate presentity for the issue or the transaction as a whole, receive a state of one of the entities, register the state of the one entity in the presentity of the one entity, determine a state of the issue or the transaction as the whole, register the state of the issue or the transaction as a whole in the presentity of the issue or the transaction as the whole, report the state of the entity to the watchers of the presentity of the entity, and report the state of the issue or the transaction as the whole to the watchers of the presentity of the issue or the transaction as a whole.

10. The apparatus of claim 7 wherein:
the presence service is further adapted to register the handler with the presentity as a proxy for the issue or the transaction, and to respond to receipt of a message to the presentity by determining the registered proxy from the presentity and forwarding the message to the handler that is the registered proxy.

11. The apparatus of claim 10 wherein:
the presence service is further adapted to deregister the handler as the proxy from the presentity, and register a second handler, to whom initial said handler has handed off the issue or the transaction, as the proxy for the issue or the transaction with the presentity.
